(19) United States
(12) Patent Application Publication
(10) Pub. No.: US 2001/0033488 A1
(43) Pub. Date: Oct. 25, 2001

(54) Electronic flame

(76) Inventors: Alex Chliwnyj, Tucson, AZ (US); Tanya D. Chliwnyj, Tucson, AZ (US)

Correspondence Address: Alex Chliwnyj, 6380 N. Yuma Mine Rd., Tucson, AZ, 85743, US

(21) Appl. No.: 09/783,374

(22) Filed: Feb. 15, 2001

Related U.S. Application Data
(60) Provisional application No. 60/182,285, filed on Feb. 14, 2000.
(60) Provisional application No. 60/222,983, filed on Aug. 4, 2000.

(51) Int. Cl. F21V 9/00

(52) U.S. Cl. 362/231; 362/183; 362/392; 362/800

(57) ABSTRACT

The invention provides improved flame-simulations via electronic flame simulation. In one embodiment, a microprocessor-based electronic artificial flame uses multiple LEDs that are controlled to give the appearance of flame motion (or “dance”). In one embodiment, the use of a white LED or LEDs to whiten the top of the flame and a blue LED or multiple blue LEDs to give a hint of blue at the bottom of the flame greatly improves the realism of the resulting simulated flame.

### CROSS-REFERENCE TO RELATED APPLICATIONS

This patent application is related to and claims priority from Provisional U.S. patent application Ser. No. 60/182,285 by Chliwnyj, filed on Feb. 14, 2000, and from Provisional U.S. patent application Ser. No. 60/222,983 by Chliwnyj, filed Aug. 14, 2000.

### BACKGROUND OF THE INVENTION

1. Field of the Invention

The invention relates generally to electrical lighting apparatuses, and, more specifically, the invention is related to systems and methods for mimicking a natural flame.

2. Problem Statement and Shortcomings of Existing Art

Systems and methods for mimicking or simulating a fire-based flame (hereinafter, “flame”) have been sought for years. Christmas lights replaced candles tied to Christmas tree branches early in the ₂₀^{th} century. Electric light-bulbs are now commonly used in cathedrals and sanctuaries to simulate the light effects of a flame. In addition, light bulbs may be purchased that have the shape of a flame. However, few efforts have been made to reproduce the visual “dance”, “sway” and color schemes of flames.

Some flame simulation devices attempt to simulate a flame by producing an artificial flame (or “simulated flame”) using electronics to articulate lights, which may be embodied as lighting elements such as Light Emitting Diodes (LEDs) or incandescent lighting devices. However, despite the type of circuit (analog or digital) used to drive the lighting elements, a very limited set of patterns is generated, and, thus, the artificial flame's simulation is unconvincing. In addition, the artificial flame often fails even as a source of entertainment because the typically small number of light-patterns is quickly recognized, and soon after becomes boring. Even worse, some flame simulation devices “flash” the lighting elements very quickly and with such a high intensely that the lights are more disturbing and jarring than they are soothing.

A more realistic artificial flame simulation is achieved by using a microprocessor control to manipulate the artificial flame's articulation (or “dance”). However, this positive step towards effective flame simulation is limited in its effectiveness by flame simulation devices that use either a single LED, or a plurality of single-color LEDs. Accordingly, existing flame simulation devices are easily identified by an untrained eye, even from a distance, by the unrealistic-looking flame simulation they employ. Furthermore, flame simulation device improvements have historically addressed cost or power usage issues (typically, by using fewer LEDs), while ignoring the need for a more realistic looking flame. Therefore, what is needed is an flame simulation device and method that that more closely resembles a true fire-based flame. The present invention provides such a device and method.

### SUMMARY OF THE INVENTION

The present invention provides technical advantages as a device and method that provides improved flame-simulations via electronic flame simulation. In one embodiment, a microprocessor-based electronic artificial flame uses multiple LEDs that are controlled to give the appearance of flame motion (or “dance”). The flame simulation may be rendered more realistic by using LEDs or other lights selected and distributed as is found in a fire-based (or “natural”) flame. In one embodiment, the use of a white LED or LEDs to whiten the top of the flame and a blue LED or multiple blue LEDs to give a hint of blue at the bottom of the flame greatly improves the realism of the resulting simulated flame. Additionally effective simulation may be realized by the selection of a preferred color-based arrangement of LEDs, and by the choice of light beam angles.

In an alternative preferred embodiment, an arrangement of colors is selected in order to mimic the color distribution of a flame. The artificial flame is whiter at the top, with red, orange, and yellow colors predominating in the middle. The bottom of the artificial flame is preferably blue. Some embodiments use different light beam angles of the LEDs, as well as the placement of the LEDs, to achieve a color separation that when articulated, appears like a fire-based flame. An optional diffuser for the blue LED can be used to soften the blue light and also prevent it from mixing with the other colors.

In another embodiment, the present invention provides a flame simulation that can be used as a direct replacement of a light-bulb in an existing lighting fixture. Thus, an existing fixture may provide more pleasing and longer lasting light.

It is envisioned that the invention will find industrial applicability in religious institutions, in architectural lighting fixtures, in lighting fixtures, in combination with a urn as an “eternal flame” for internment, or for the storage of cremated remains. These advantages, and other features, objects and advantages of the present invention are described or implicit in the following Detailed Description of Preferred Embodiments.

### BRIEF DESCRIPTIONS OF THE DRAWINGS

Features of the invention will be apparent to those skilled in the art from the following detailed description of the invention, which should be read in conjunction with the accompanying drawings, in which:

FIG. 1A is a drawing of a flame;

FIG. 1B is a drawing of a flame simulation device showing an arrangement of light emitting diodes (LEDs) used to achieve the appearance of a flame;

FIG. 1C illustrates a color arrangement of LEDs in a housing for simulating a flame;

FIG. 2 is a side view of a housing with an alternative circuit board physical arrangement;

FIG. 3 is a block diagram of a low voltage lighting unit;

FIG. 4 shows a low voltage light bulb designed to plug into an industry standard wedge socket;

FIG. 5 is an alternative design showing a different connector orientation for a low voltage light that plugs into a wedge base;

FIG. 6A is an exemplary packaging option for the low voltage lighting unit having an “L” shaped design;

FIG. 6B is an exemplary packaging option for the low voltage lighting unit having a “T” shaped design;

FIG. 7A is a front perspective of a flame portion;

FIG. 7B is a side perspective of a light unit in a fixture particularly showing how the physical relationship of the LEDs in relationship to the diffuser (or a translucent window) gives the appearance of motion;

FIG. 8 is a side view showing the addition of a shadow mask to create an outline of a flame shape on a diffuser window;

FIG. 9 illustrates a shadow mask; and

FIG. 10 shows an alternative shadow mask that incorporates a central section representative of a dark area around a wick.

### DETAILED DESCRIPTION OF THE INVENTION

The invention is an aesthetically pleasing and soothing flame simulation device and method. The invention closely mimics the motion and color patterns of a real flame by using a plurality of light emitting diodes having selected colors. The invention achieves advantages over the prior art by distributing colors within a flame portion, such as a diffuser, of the flame simulation device.

Natural Flame

A real, or natural, candle flame (flame) has a lower color temperature than artificial light sources. A natural flame has a portion at the bottom that is blue, a darker middle portion, and a brighter yellow or white-like top portion.

To reproduce this effect, LEDs are chosen and organized in an order that effectively reproduces a flame. Preferably, an artificial flame includes a blue LED as the lower-most LED in a series of LEDs. Accordingly, the blue LED adds realism to the flame simulation, particularly in those applications that use a shadow mask, or a glass cover. The blue LED can be used alone, or in combination with other LEDs, such as a white LED, to enhance the simulation. Furthermore, a white LED used in combination with other LEDs can help alleviate redness problems associated with simulated flames.

Unfortunately, creating a realistic-looking candle flame is not as easy as selecting color combinations that mirror the colors in a natural flame. This is because the light produced by LEDs interacts with itself and creates an optical effect that does not preserve the intended color combinations. Accordingly, the combination of a yellow or amber/orange LEDs with white LEDs can look too blue-white. In addition, a white LED can give a blue cast, and a yellow LED or an orange LED can be too reddish to simulate a candle flame. Compounding these issues is that fact that over the life of the LEDs the relative intensities of the yellow and white LEDs may change.

Accordingly, some way of controlling the perception of the color of the flame is required. An addition of a blue LED at the bottom of the artificial flame gives a way to control the perception of the white light produced by a white LED. Thus, if the white LED is too blue to simulate a flame, one way to make the artificial flame appear more yellow is to add a blue LED as the bottom-most LED (the addition of the blue LED tricks the eye and brain into seeing the white as more yellow). Therefore, the blue LED is used to make the white LED look less blue (and at the same time makes the white LED look more yellow), thereby producing a more realistic flame simulation.

Accordingly, the invention provides, in one embodiment, a flame simulation device. The flame simulation device includes a LED platform having at least one light emitting diode (LED). The LED is capable of producing a light beam. The flame simulation device also includes a flame portion capable of selectively directing and capturing the light beam.

The arrangement of LEDs to achieve a realistic flame is achievable in several embodiments. For example, the flame simulation device could employ a white LED that produces a top-most LED light beam by projecting the light beam into a flame portion of the flame simulation device. A flame simulation is enhanced by a blue LED that produces a bottom-most LED light beam in the flame portion. The diffusion of the blue light is enhanced by the use of a diffuser/light pipe for channeling a light beam. In addition, the flame may be further enhanced by providing a yellow LED and/or an orange LED that produces a yellow light beam and/or an orange light beam, respectively. The yellow light beam and/or the orange light beam will be projected between a top-most light beam and a bottom-most light beam.

Additional advantages may be achieved by configuring the invention to provide additional features. For example, when a first LED has a first light beam angle that is different from a second light beam angle produced by a second LED the light beams may be selectively directed. For example, when a white LED has a narrower light beam angle than any other LED, the white LED provides a light beam to a substantially whiter top portion of a light portion. In addition a mask could be coupled to the LED platform. Preferably, the mask is configured in the general shape of a flame for enhancing an illusion of motion of a simulated flame due to the difference in distance between a lit LED and an edge of the mask. Also, it is desirable for the mask to have a dark portion for creating the effect of a wick in the middle of a simulated flame.

Other features of the flame simulation device include a power supply coupled to the LED platform. The power supply could be a low-voltage DC power supply, or be coupled to a solar powered generator. In addition, capacitors could be used to store and provide power to the flame simulation device.

The invention may be realized in several applications. For example, the flame simulation device could be configured to behave as a memorial light. Such a device would be beneficial with a cremation urn. In addition, the flame portion could be configured to behave as a memorial light. In this embodiment, the flame simulation device could be associated with a ground-based memorial marker.

In an alternative embodiment, the invention provides a method of simulating a flame in a flame simulation device by selectively articulating a plurality of LEDs, the plurality of LEDs comprising at least a white top-most LED and a blue bottom-most LED.

Description of Figures

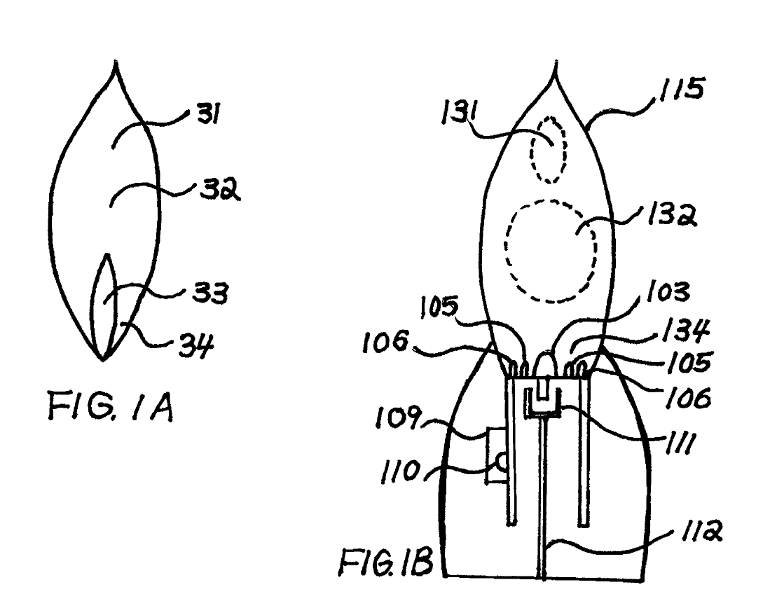

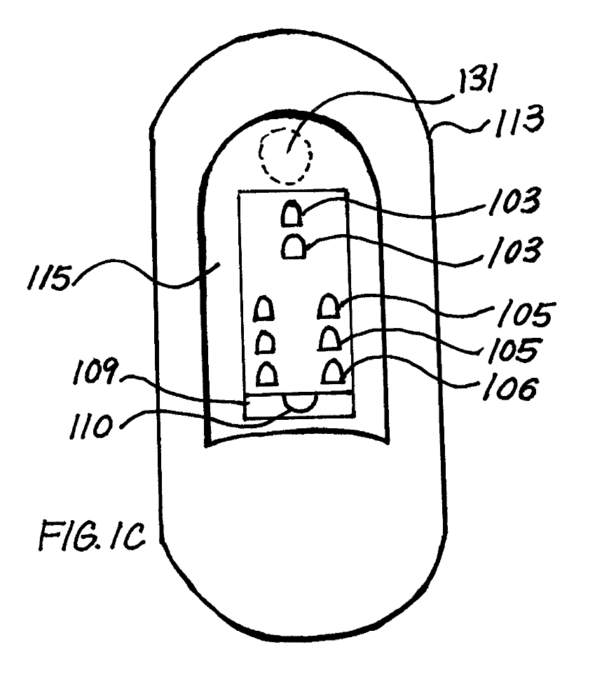

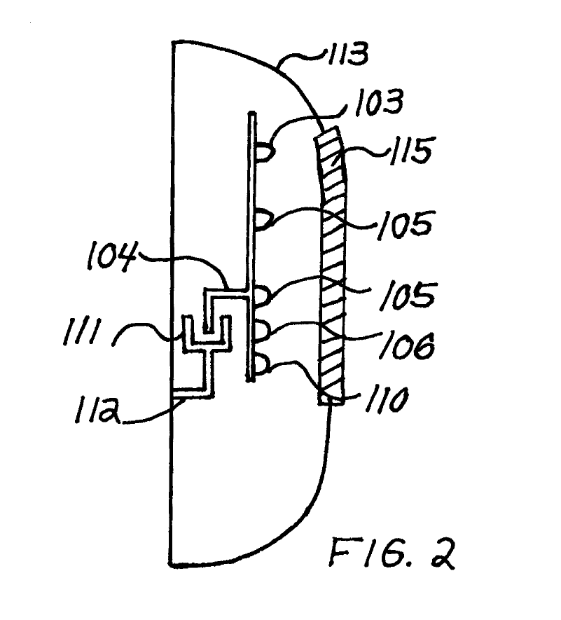

The distribution of colors in a flame 30 is shown in FIG. 1A. The flame 30 has different colored regions, including a top region 31 that is lighter in color than other regions. A middle region 32 is yellow or orange in color. A bottom region 34 provides a blue hue. Typically, a middle portion 33 of the flame 30 is darker around a wick (if present).

FIG. 1B shows an arrangement of light sources, which are preferably LEDs, that lends itself to a pleasing flame simulation. LEDs are grouped together on a light source platform, which in the preferred embodiment is a LED platform, to produce the light beams that produce three areas of color in a flame portion 115. The top of the flame portion, such as the diffuser 115, receives white light as a white light beam (hereinafter the words “light beam” may be interchanged with a reference to a produced by a LED) from a white LED 103, thereby providing a whiter region 131 at the top of the diffuser. The light beam of LED 103 is selected or controlled to be narrower than the light beam of a yellow LEDs 105 or an orange or amber LEDs 106. This allows white light to focus up to the top section of the flame portion 115. A flame portion is a structure that captures, conduits, diffuses, or otherwise prepares a light from a light source for viewing. In a preferred embodiment, the flame portion is a diffuser. In the following discussion it should be understood that the terms flame portion and diffuser are used interchangeably to describe the flame portion structure of the preferred embodiment.

The middle of the flame portion diffuser 115 has a yellow orange region 132 that is mostly lit up by yellow LEDs 105 and amber LEDs 106. The bottom of the flame portion diffuser 115 is blue in region 134 which is lit by blue LED 110 and the light is controlled by diffuser 109. In FIG. 1B, all of the LEDs are on a horizontal circuit card, and the different light beam angles of the LEDs are used to achieve the separation of the white from the different colors. The blue LED 110 may optionally have a diffuser 109 for itself to avoid a bright blue spot and to give just a hint of blue.

In one embodiment, an arrangement of LEDs on a planar surface of a LED platform is made so that each of the LEDs (the yellows, reds, and amber or orange) has a different light beam angle than the white LEDs. Accordingly, a white LED has a narrower light beam angle, in part, for separating the white light from light of other colors. In this embodiment the white LEDs 103 and yellow LEDs 105 and amber or orange or red LEDs 106 may be on the same plane. The narrow light beam angle of the white LEDs allows the majority of the white light to shine up through the top of the diffuser to provide a bright top to the artificial flame.

The light beams of non-white LEDs are selected to have a wider light beam than the white LED light beam, and should combine with the white LEDs to produce a pleasing color at the top. The other LEDs also need to shine out the side to produce a more yellow/orange/amber color in the middle. Furthermore, a blue LED 110 can be constrained with a constraint diffuser 109 to produce a very mild blue color at the bottom of the flame portion diffuser 115 (there needs to be just a hint of blue at the bottom of the flame to give the mind a visual clue that the top of the flame is a yellow white).

In FIG. 1C, the LEDs are physically separated on a vertical circuit board 100 to achieve the white region 131 on top, with the yellow region in the middle, and the optional blue region at the bottom. Accordingly, white LEDs 103 are the topmost LEDs, blue LEDs 110 are the bottom-most LEDs, and yellow LEDs 105 and orange or red or amber LED 106 are located in-between the white LEDs 103 and the blue LEDs 110. The flame portion diffuser 115 is preferably constructed from a semi-transparent piece of glass or plastic. Furthermore, a housing 113 is made of an opaque material.

A candle flame is a point source that produces light all around it. A real candle flame illuminates the entire area when it is positioned in a bookshelf or alcove. With the electronics constructed on a flat circuit card, as shown in FIG. 2, light shines only out the front of the lighting fixture 113 through the diffuser 115. If the back of the housing 113 is open or has a transparent or translucent window then the light from the flame simulation could also shine through the back of the circuit card. By using a translucent circuit card such as a thin fiberglass card, light shines out the back of the lighting fixture. When the housing is positioned in an alcove or on a shelf, light will shine light out the rear, the front, and the sides to produce the appearance of a real flame.

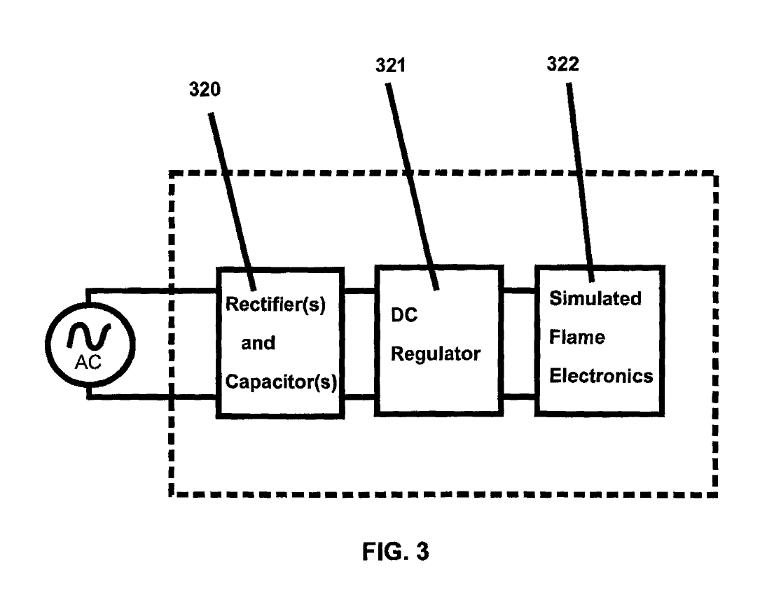

FIG. 3 is the overall block diagram of how a low voltage light bulb replacement embodiment of the invention is constructed. The overall lighting unit may be constructed in three major parts. First, the incoming AC power is rectified and filtered by a rectifier and capacitor 320. Second, the raw DC power is regulated to a lower voltage for the microprocessor and LEDs by a DC regulator 321. Then, circuitry 322 is used to direct the production and articulation of the simulated flame.

Electrical current for driving the LEDs may be modeled as a mathematical function across time. Preferably, the flame sequence is a combination of sine wave values. However, additional functions are selectable. For example, a different mathematical function, such as a periodic sine or cosine wave, a triangular (or saw-tooth) wave, or other periodic function could provide modulation. In fact, any arbitrary function could be selected to provide the fundamental building block of the flame simulation. In one simple implementation, it could be as simple as an up/down counter.

Another feature of the artificial flame of the invention is the addition of a gaussian number generator(s) based on the application notes from Micro Chip for the PIC processors. The gaussian number generators generate a series of numbers, from an underlying random number generator that, tend to have a gaussian distribution. This is used to make the flame go faster or slower. The gaussian nature of the numbers insures that the flame will have a pleasing pattern as the variations will tend to the mean and the disturbances will happen occasionally. The magnitude of the disturbance, or the speed of the disturbance, etc., can be designed to be proportional to the distance of the gaussian number from the mean of the distribution. That is to say that the fast or slow excursions of the flame will happen more often than the very fast or very slow excursions. This provides a pleasing flame that has a randomness that can not be achieved in any other way with an analog solution or a digital sequencer.

It is the introduction of the randomness (for controlling the speed of the flame), with a distribution of fast and slow activity, that is pleasing, and that, in the long run, that gives a realistic look to the flame simulation. In an installation with potentially thousands of lamps on a single low voltage AC transformer it is desirable to have them all with a high degree of randomness and to avoid synchronization (so that no two flames begin a sequence at about the same time). The flames should all appear to be random to an observer.

Another method for achieving randomness is the startup sequence. Imagine a thousand lamps all on the same circuit energized at the same time. Some means is necessary of assuring that the starting point for all of the sequences is not the same (two different lamps in close proximity moving in synch would completely ruin the flame illusion). One means to solve this problem of starting each flame simulation device on a different sequence is to pull some numbers out of initialized memory and start the random number generators from there. Another one that is specific to some processors is a solution using an ID register. When the one time programmable (OTP) processors are programmed, the value in the ID register can be incremented for each part that is programmed by some programming hardware. This would assure that at least one of the pseudo random number generators used by the algorithms would be in a totally different state. Due to the nature of pseudo random number generators implemented in digital logic a number incremented by one (1) would provide a starting point in the sequence that is located a long numerical distance away in the sequence.

The combination of the two methods should provide reasonable assurance that two lamps in close proximity, even from the same manufacturing lot, will not be in synchronization. One final method is to throw in some further means of preventing synchronization and that is to make the specification on the microprocessor frequency reference a loose tolerance. Today's quartz crystals used for microprocessor frequency control have a very tight tolerance that is required for most applications. However, the present invention would desire quartz crystals with a wider range of frequencies. If the distributions of the frequencies were wider, then even if two lamps got into synchronization, they would drift out of synchronization in a very short time.

The circuitry preferably uses a processor, such as a microprocessor or a digital signal processor (DSP) to perform the computations and control. It should be evident that a digital algorithm implemented on a processor could be implemented in digital hardware of sufficient complexity. A suitable application specific integrated circuit, also known as an (ASIC), could be designed to perform the functions of the processor if the volumes were enough to justify the design costs. Circuits can include memory elements and read only memory (ROM) to hold waveform tables for example. The pulse width modulation (PWM) portion of the algorithm is especially suited to a hardware implementation. A very simple form of the device could also be built using a field programmable gate array (FPGA) to reduce the overall system cost. Of course, the invention could also achieve desired waveforms by using a custom digital chip.

One preferred embodiment uses a PIC16C622 from Micro Chip. However, there are many suitable microprocessors from Micro Chip and other suppliers that could be used for the application. Additionally, many microprocessor chips have sufficient current source or sink capability to directly drive the LEDs without a separate driver. This allows a minimal design with PWM in software for a single chip solution. Thus, one implementation is to use a PIC12C671 processor with an internal frequency reference and a plurality of LEDs including a white and blue LED, each with a current limiting resistor.

Low Voltage Lighting Unit Embodiment

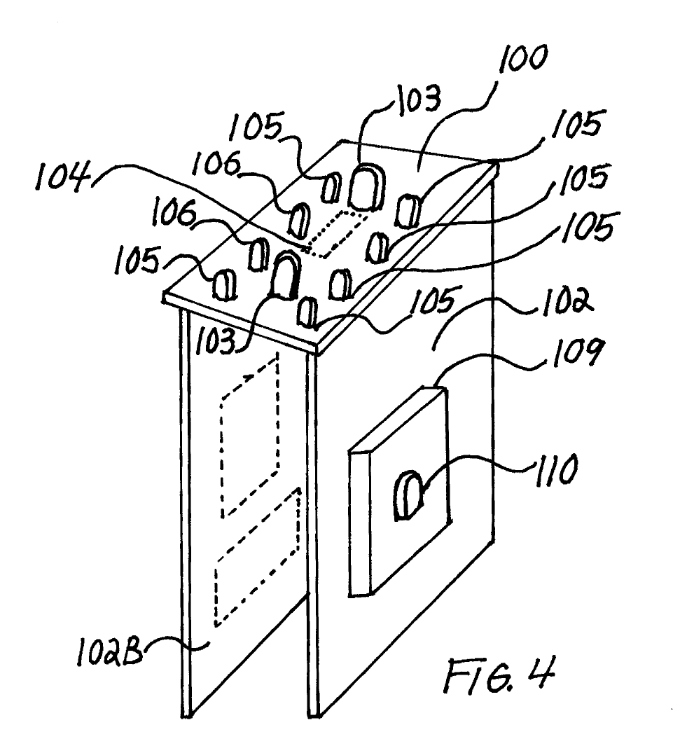

In one embodiment, the invention is a replacement for a low voltage light bulb, as shown in FIG. 4. This light bulb (or lighting unit) is compatible with new and existing lighting fixtures which operate on low voltage AC power. The lighting unit provides a circuit board. LEDs (103, 105, 106) are disposed on a circuit board 100. White LEDs 103, preferably having narrow light beam angles of about 15 degrees in one embodiment, are located in approximately the center of the circuit board for shine up to the top of a flame portion diffuser, such as a flame portion diffuser 107. Red, orange, or amber LEDs 106 located about edges of the circuit board 100. Also along the edges of the circuit board are yellow LEDs 105, for lighting the flame portion diffuser. Other circuit boards 102A and 102B are for maintaining a power supply and other electronics. An edge connector 104 is preferably a piece of circuit board that is designed to plug into a socket for a standard wedge-base low voltage lamp.

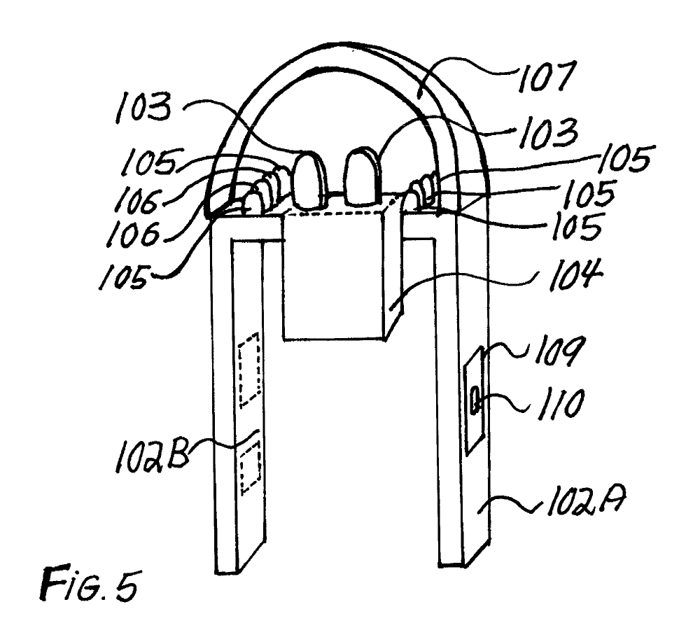

The electronics can be packaged in any manner so as to fit in the space allowed. As long as the physical package will fit into the allowable space and has a connector 104 to conform with the socket it is designed to mate with. Note, however, that the connector 104 need not be strictly configured as shown in FIG. 4. For example, FIG. 5 shows a simple variant of a flame simulation device having an edge connector 104 at a 90 degree-offset from the flame simulation device of FIG. 4. This allows for additional connective designs for the flame simulation device.

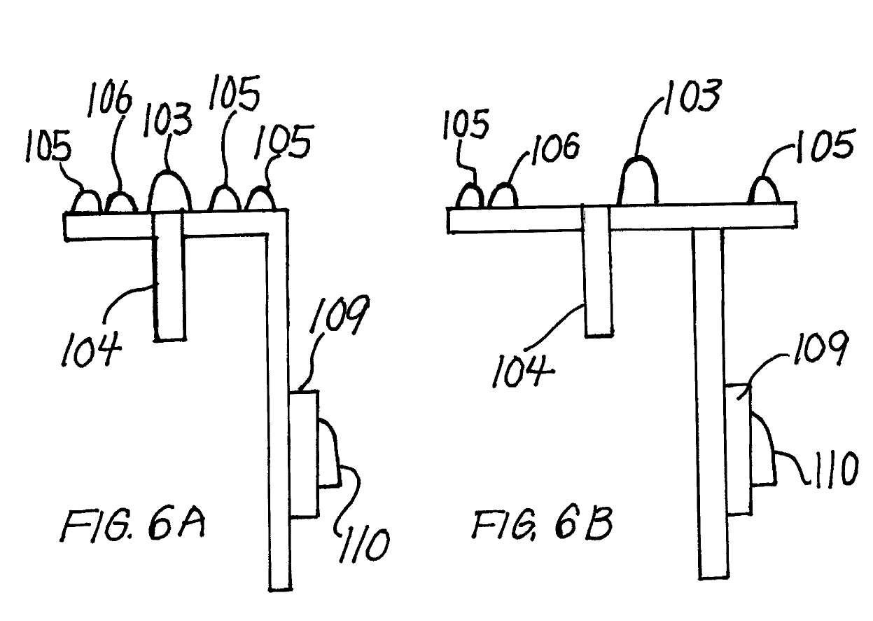

FIG. 6A shows an alternative embodiment of the flame simulation having an “L” packaging design. Similarly FIG. 6B illustrates an alternative embodiment of the invention having a “T” design. Like numerals in FIGS. 4, 5, 6A and 6B represent like items, and should guide the reader in understanding the figures. Preferably, the power supply and the microprocessor electronics are combined on one circuit card to take up less volume and to reduce the cost of the final design. In addition, the printed circuit card could have electronic components on both sides of the circuit card.

To achieve the intended visual effect of a simulated flame, the system may employ a diffuser as a flame portion to selectively blend the colors of the LEDs together. In one preferred embodiment, a diffuser can either be a part of the “light bulb” as shown in FIG. 5, with or without a clear cover to represent a flame shape, or the diffuser can be a part of the lighting fixture as shown in FIG. 1B. Referring again to FIG. 1B, circuit card assembly is illustrated as being plugged into socket 111, supported on bracket 112, and enclosed in a diffuser 115. A housing 113 is typically made of metal or other heat-resilient material. In addition, the diffuser 115 is preferably constructed of glass, plastic, or another translucent or transparent material. The diffuser 115 can have a frosted or otherwise matte finish to diffuse the light. In another embodiment, a diffusing element is mounted directly on the electronics assembly, and in yet another embodiment, the diffuser is integrated with the lighting fixture. When the LEDs are very close to a glass or a plastic diffuser, a single diffuser may not provide an adequate flame simulation. When there is not enough physical space between the LEDs and the diffuser due to the construction of the housing, the preferred device will employ a plurality of diffusers.

The physical arrangement of the LEDs, in addition to careful choice of the LED light beam angles, is used to achieve the selective placement of colors in the simulated flame. Accordingly, in one embodiment, the white LEDs 103 are physically placed in the center of the circuit board to be near the center of the substantially flame shaped diffuser (as illustrated in FIG. 4). The white LEDs 103 have an approximately fifteen (15) degree light beam angle to project the bulk of the white light to the top of the diffuser. Comparatively, in this embodiment, the non-white LEDs will have a light beam angle of approximately 30 degrees. The result is a simulated flame with the uppermost portion being substantially whiter than the middle or the lower region. Likewise, the orange LEDs 106 and yellow LEDs 105 are placed substantially further from the center of the diffuser than the white LEDs 103 and have a wider light beam angle in order to light up all portions of a diffuser.

A blue LED 110 is preferably placed lower (bottom-most) in relation to the other LEDs to provide a blue bottom to the flame. Optionally, the blue LED can be combined with an additional separate (or integrated) diffuser and/or a light pipe 109 to soften the intensity of the blue LED's light, and to guide the blue light to the bottom of the simulated flame. It is desirable to separate the blue light from the reddish orange light of the rest of the flame since an undesirable purple cast light may result if the blue light is allowed to combine with the reddish orange light.

The physical placement of the blue LED away from the other LEDs, and the placement of an optional diffuser about the blue LED 110 prevents mixing of the colors in an undesirable way. In addition, the intensity of the blue light can be adjusted to achieve the desired effect. The intensity can be increased to give more of a gas flame effect, or decreased for more of a candle flame effect. The relative proportion of the blue light that is selected will depend on the ambient lighting conditions and the color temperature of the ambient light. Accordingly, algorithms may be written for a processor to automatically adjust light intensities of the LEDs based on detected ambient lighting conditions.

Because mausoleum embodiments are within the scope of the invention, it should be noted that it is desirable produce an embodiment of the flame simulation device that is a direct replacement for a 24 volt, 3-watt incandescent lamp (the standard in the mausoleums). It is desirable to operate on 24 volts AC and, if possible, to decrease the power required.

A transient voltage suppressor (TVS) may be incorporated in a power supply design. In a system with multiple units on a single transformer there exists the possibility of a short circuit when a unit is removed or replaced. The TVS is required to absorb the large voltage spike that is generated when the secondary of the low voltage transformer is shorted and the short is removed. The lighting unit may also be constructed with a linear power supply where the power dissipation is of little importance and the initial cost is the overriding concern.

Lighting Unit with Shadow Mask Embodiment

One way to add realism to an artificial flame is to use a shadow line. If LEDs are spatially separated, an edge of a piece of material can be used to produce a varying shadow line. In a votive candle, or a large diameter candle, there is a shadow line when the candle burns down and the flame is contained within the candle body. The body of the candle forms a screen for an internal flame, which behaves like the bulb in a projector to light the exterior of the candle, which is often ornamented to create a “stain glass” effect. The movement of the flame produces a shadow at the juncture of the hollow interior and the solid candle exterior. As the flame dances, the shadow line appears to dance (when viewed from the outside of the candle).

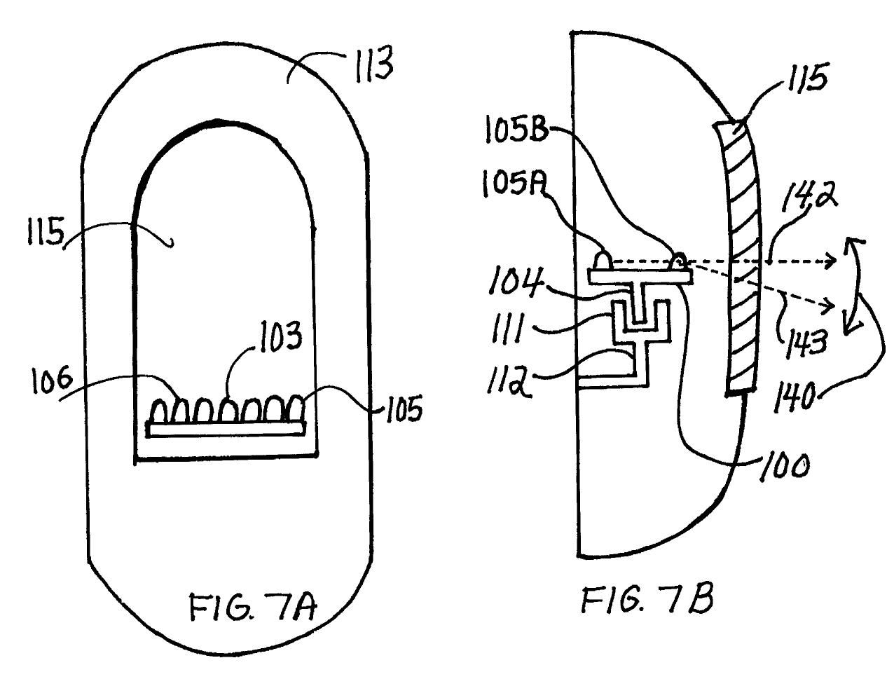

FIG. 7A illustrates a front-view of an flame portion embodied as a light diffuser. FIG. 7B shows how the spatial separation of the LEDs 105 and an edge 142 can be used to produce a moving shadow line 143. As the LEDs that are closer to the edge 142 brighten and the LEDs that are farther away from the edge 142 dim, the geometry of the LEDs relative to the edge 142 changes, and the light projected on the diffuser 143 appears to travel up and down. According, one shadow angle appears from a line created by back-most LED 105a to the edge of the circuit board 100 (top of arc 140), and a second shadow angle is formed by the line created by the front-most LED 105b to the edge of the circuit board 100 (line 143). It is the different angles of the light from the LEDs across the arc 140 that casts a moving shadow. When the different LEDs turn on and off, the shadow cast on the diffuser 115 moves up and down the arc 140, depending on the proximity of the LED to the edge of the circuit board 100.

One embodiment uses a part to specifically cast a shadow, and does not rely on the edge of a circuit board. This part causes a shadow line. This effect is a very subtle clue to the brain that there is a real flame in the glass and the flame is moving. Tests have shown that people think that the flame is more realistic when there is an edge causing this moving shadow.

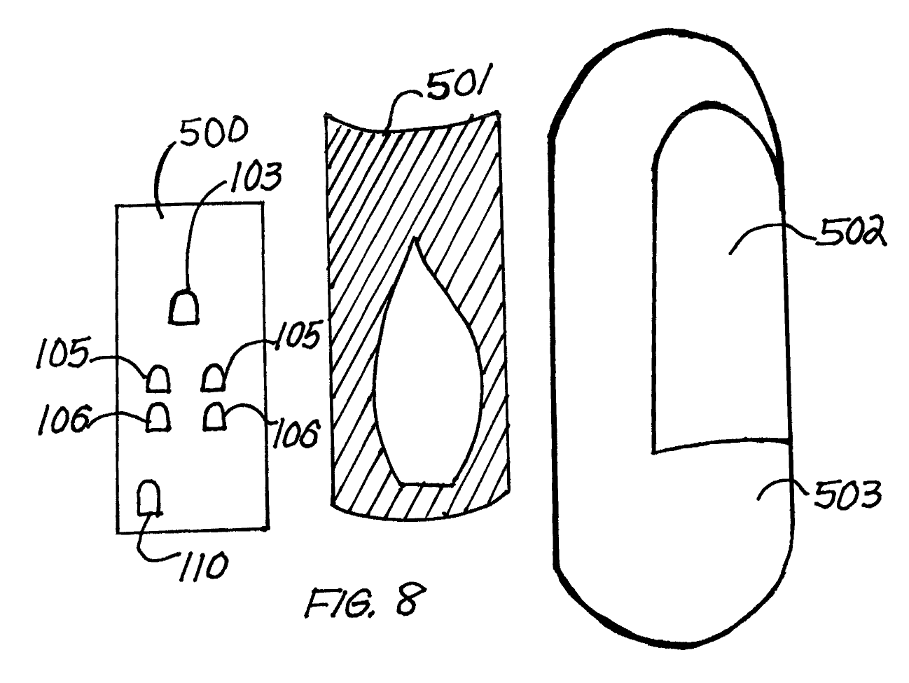

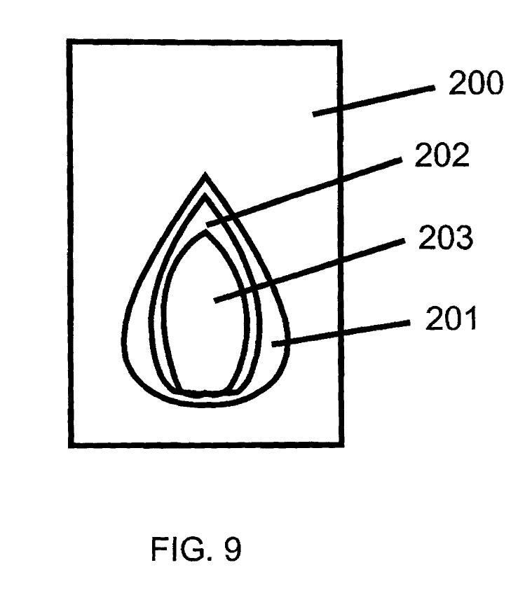

A different mechanism for a different embodiment of the invention, which produces a similar moving shadow effect is shown in FIG. 8. The light from the circuit card 500 is controlled by the mask 501 and goes through the diffuser window 502 in the housing 503. This embodiment uses a special part to specifically cast a shadow and does not rely on the edge of the circuit board. This part causes the shadow line. A mask is specifically used to produce an outline of a typical candle flame shape. An example of a mask is shown in FIG. 9.

The mask of FIG. 9 provides a backing 200 that is in a preferred embodiment 90 to 100 percent opaque, whereas the center 203 of the flame is clear. A first region 201 and a second region 202 can provide gradual, step-like changes between the clearness of the center 203 and the opacity of the backing 200. An outline to the flame image may also be provided.

The mask can be combined with an electronics assembly, or combined with a diffuser, or be a separate element. The diffuser can also be located on the LED side of the electronics, or the far side of the shadow mask. Yet another embodiment provides a shadow mask that is located on the far side of the diffuser. When used alone or in conjunction with the flame simulation device, a shadow mask adds to the visual illusion of a flame (the flame shape being another visual clue that tricks the brain into thinking a natural flame is present). The design of the mask and the placement of the LEDs can give the flame the appearance of becoming shorter or taller, as well as the appearance of growing wider and shrinking narrower, and can be made to move from side to side by alternately brightening and dimming LEDs on opposite sides of a mask.

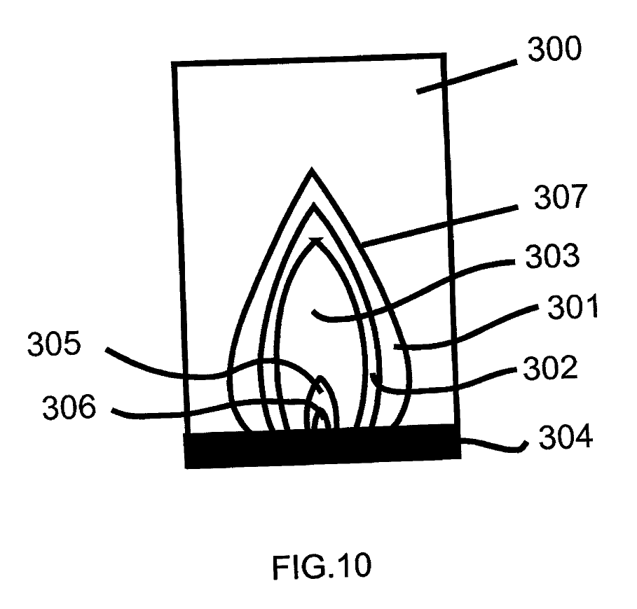

As shown in FIG. 10, the mask may be graduated or shaded. The background 300 is preferably about 92 percent opaque in this embodiment, although other degrees of opaqueness are acceptable. A center 303 of the flame is clear. The second region 302, and the first region 301 are graduations from the clearness of the center 303 to the background shade 300. A dark line 307 outlines the first region 301 in one embodiment, and is provided as a matter of consumer preference.

Any dark portion of the shadow mask is not required to be 100 percent opaque. One option is to have a dark outline directly around the candle flame to give the candle shape. At the periphery the mask can be lighter. Background 300 could be lighter or darker than the outline of the flame. The region 304 at the bottom of the flame is provided to help control the light from the blue LED.

A flame in a container would light up the container. The lighter background can allow some light to leak out. This gives some background light in the window while creating the shadow effect and motion as described above. This embodiment employs 90 to 92 percent opacity for the outline (as printed on clear transparency on a laser printer). Motion effect can be achieved with a hard or soft edge which enhances the apparent motion.

The shadow mask of FIG. 10 also provides a wick 306. When providing a wick, region 305 is a slightly shaded region. The slightly shaded region 305 is preferably about 20 percent opacity (to give a very slight shadow). The motion effect that is caused by the “wick” shadow adds even more realism in a subtle way.

The mask can also be utilized in a self-contained light bulb or other device that is not single sided. It could be a dual-sided design or even a three, four, or more-sided design, or of a design that takes approximately the shape of a bulb. The flame shape could be either designed to be small like a candle flame or larger than a candle flame (for example, to provide a large flame that is visible from a great distance).

Low Voltage Lighting Unit with Common Power Supply Embodiment

Some lighting applications, such as cemetery, church, or architectural lighting, require multiple lighting units in a relatively close proximity. In new lighting installations, a system with multiple units could be used with a central power supply converting AC to low voltage DC. Low voltage DC power is then distributed to each individual lighting unit.

A single AC to DC power supply provides the benefit of lower overall to system cost. An additional benefit of the centralized power conversion is an increased reliability of the individual lighting units, due to the reduced temperature of the individual units. For example, one preferred embodiment provides individual lighting units that run on 5 volts DC. A single 5 volt power supply, for example, a switching power supply, is used in a central location to power all of the flame simulation devices in parallel.

To avoid a possible disadvantage of polarity problems, each flame simulation device uses a diode (configured as a current-gate, or “blocking diode”) to protect the lamp in the event that it is plugged in at a reverse polarity. Another solution to this potential problem is to use a flame simulation device having a base that could be rotated 180 degrees to engage a location-specific ground wire.

Low Voltage Niche Lighting Embodiment

Yet another embodiment of the invention applies compact robust lighting technology for niches of cremated remains. A columbarium is a collection of niches for the storage of cremated remains. One of the problems that arises when lighting the front of a standard opaque cremation niche is the limited amount of room on the face of the niche (the frontal area is typically about 11 inches by 11 inches) and typically the front of the niche is made of natural stone. Generally, it is desired to place a name and dates of birth and death of the deceased on the frontal area of the niche. This leaves little room for ornamentation. Thus, low voltage incandescent lighting is commonly being used on niche fronts because of its appropriate beauty and because of the small amount of space it occupies. The present invention is easily incorporated with, and provides advantages to, niches.

Glass front niches provide a way of viewing displayed urns and personal artifacts. It is desirable to light glass front niches from within in order to enhance the appearance of the memorial items that are on display. However, incandescent lighting creates maintenance problems. A lighting technology using LEDs enables the glass front niches for cremated remains to be lit from within, without the maintenance problem of changing light bulbs. The present invention enables a glass front niche with a transparent or translucent front to be lit from within with a simulated flame. Lighting the niche from within creates the possibility of illuminating graphics, art, text, or a likeness of the deceased on the front of the niche.

Plastic Injection Molded Lamp Embodiment

Yet another embodiment of this design is the application of injection molded plastic to the design of a flame simulation device. The portion of the flame simulation device that plugs into a socket has two wires (like the wedge base of all glass lamps that it is designed to replace). Wires are imbedded in the plastic and come up to join the electronics assembly on the plane of the LEDs. The electronic circuitry is mounted on one or two vertical members that are also part of the plastic assembly. The entire assembly is composed of one or more plastic injection molded parts. Electronics are hidden beneath a plastic cover that is affixed to the assembly.

Cemetery Marker Embodiment

One problem encountered with cemetery application of the present invention is that batteries, even rechargeable batteries, have to be replaced periodically. The available battery technology is unreliable, especially when exposed to the elements and extremes of temperature that are experienced by a flat marker exposed to the sun and to winter weather.

The invention provides a solution by using a capacitor (or capacitors) to provide power to the LEDs. For example, a new generation of “super capacitors” is available from Evans Capacitor Company. This technology make it practical to build a solar powered lighting unit to charge capacitors that operate for a very long period of time without any maintenance. The manufacturer projects a lifetime of at least 25 years for the capacitors.

Accordingly, the invention combines a simulated flame with capacitors, along with photovoltaic panels and control circuitry to produce an extended to lifetime solar powered simulated flame This solar powered simulated electronic flame light operates for many years without the maintenance of replacing batteries. The invention makes it possible to construct a memorial or monument with a sealed unit to keep out moisture and other elements. One other style of memorial encompassed by the invention is a free standing solar powered memorial having an artificial flame.

Furthermore, it should be understood that while although the light sources (in the preferred embodiments, LEDs), are described as having specific colors, it should be understood that light waves exist in spectrums and that the reference to a specific color should not be interpreted as being limited to a textbook-specific embodiment of one light wave within the generally accepted spectrum of that colors general spectrum of color (which will vary due to a variety of atmospheric and environmental considerations, such as temperature, atmospheric pressure), crystal type and purity, and a number of other factors.

It is intended that the forging detailed descriptions be regarded as illustrative rather than limiting, and that it be understood that it is the following claims, including all equivalents, which are intended to define the scope of this invention.

What is claimed is:

1. A flame simulation device, comprising:
a LED platform having at least one light emitting diodes (LED) thereon, the LED capable of producing a light beam; and
a flame portion capable of selectively directing and capturing the light beam.

2. The flame simulation device of claim 1 wherein the LED platform has at least a white LED for producing a top-most LED light beam.

3. The flame simulation device of claim 1 wherein the platform has at least a blue LED for producing a bottom-most LED light beam.

4. The flame simulation device of claim 1 wherein the platform has at least a yellow LED that produces a yellow light beam, the yellow light beam located between a white top-most light beam and a blue bottom-most light beam.

5. The flame simulation device of claim 1 wherein the platform has at least an orange LED that produces an orange light beam, the orange light beam located between a white top-most light beam and a blue bottom-most light beam.

6. The flame simulation device of claim 1 wherein the platform has at least a yellow LED for producing a yellow light beam, and an orange LED for producing an orange light beam, the yellow light beam and the orange light beam located between a top-most light beam and a bottom-most light beam.

7. The flame simulation device of claim 1 wherein the flame portion comprises at least a yellow LED and an orange LED located between a white top-most LED and a blue bottom-most LED.

8. The flame simulation device of claim 1 further comprising a diffuser/light pipe for channeling a light beam.

9. The flame simulation device of claim 8 further comprising a blue LED, the blue LED being a bottom-most LED.

10. The flame simulation device of claim 1 further comprising a power supply coupled to the LED platform.

11. The flame simulation device of claim 10 wherein the power supply is a low-voltage DC power supply.

12. The flame simulation device of claim 11 wherein the LED platform comprises an arrangement of a plurality of LEDs on a substantially planar surface, wherein at least a first LED has a first light beam angle that is different from a second light beam angle produced by a second LED.

13. The flame simulation device of claim 12 wherein a white LED has a narrower light beam angle than any other LED for providing the flame a substantially whiter top portion.

14. The flame simulation device of claim 1 wherein the flame portion is configured to behave as a memorial light, the flame simulation device being associated with a cremation urn.

15. The flame simulation device of claim 1 wherein the flame portion is configured to behave as a memorial light, the flame simulation device being associated with a ground-based memorial marker.

16. The flame simulation device of claim 10 wherein the power supply is coupled to a solar-power generator.

17. The flame-simulator of claim 16 wherein the solar-power generator is coupled to at least one capacitor for storing electrical energy.

18. The flame-simulator of claim 1 further comprising a mask coupled to the LED platform, the mask configured in the general shape of a flame for enhancing an illusion of motion of a simulated flame due to the difference in distance between a lit LED and an edge of the mask.

19. The flame-simulator of claim 18 wherein the mask comprises a dark portion for creating the effect of a wick in the middle of a simulated flame.

20. A method of simulating a flame, comprising:
selectively articulating a plurality of LEDs, the plurality of LEDs comprising at least a white top-most LED and a blue bottom-most LED
